(19) United States
(12) Patent Application Publication
(10) Pub. No.: US 2017/0296416 A1
(43) Pub. Date: Oct. 19, 2017

(54) ADJUSTABLE HEIGHT MEDICAL PROCEDURE TABLE

(71) Applicant: MEDICAL POSITIONING, INC., KANSAS CITY, MO (US)

(72) Inventors: DAVID SCOTT, OVERLAND PARK, KS (US); ZOUHAIR TALBI, PRAIRIE VILLAGE, KS (US); GHASSAN DINN, KANSAS CITY, MO (US)

(73) Assignee: MEDICAL POSITIONING, INC., Kansas City, MO (US)

(21) Appl. No.: 15/487,009

(22) Filed: Apr. 13, 2017

Related U.S. Application Data
(60) Provisional application No. 62/323,302, filed on Apr. 15, 2016.

(51) Int. Cl. A61G 13/06; A61G 13/04; A61G 13/00; A61G 13/08; A61G 13/12; A61G 15/02

(52) U.S. Cl. CPC A61G 13/06; A61G 13/12; A61G 15/02; A61G 13/0018; A61G 13/08; A61G 13/04; A61G 2203/726

(57) ABSTRACT

The present invention is directed to an adjustable height medical procedure table that can be moved between a first low position and second high position by a scissors lift. The table includes various features to prevent collisions when the table moved to the first low position.

### CROSS-REFERENCE TO RELATED APPLICATIONS

This application is based on and claims priority to U.S. Provisional Application Ser. No. 62/323,302, filed on Apr. 15, 2016, which is incorporated herein by reference in its entirety.

### STATEMENT REGARDING FEDERALLY SPONSORED RESEARCH OR DEVELOPMENT

Not applicable.

### BACKGROUND OF THE INVENTION

### 1. Field of the Invention

The present invention is directed to the field of adjustable height medical procedure tables for use in medical procedures, analysis and treatments.

### 2. Description of Related Art

Adjustable height medical procedure tables are commonly used in hospitals and clinics. One problem with known adjustable height medical procedure tables is that most, if not all, cannot be lowered to a height of 19 inches or less. Known tables have recesses (sometimes referred to as access sites) that allow technicians and medical care providers to perform procedures and/or examinations of a patient. The recesses are often covered with inserts (sometimes referred to as filler sections) that can hang in a vertical position when in an open position to allow technicians and medical care providers to access the recesses. The corners of the recesses—which the inserts are positioned within—are also sharp and can cause discomfort or injury to patients, technicians, or medical care providers.

### BRIEF SUMMARY OF THE INVENTION

The present invention is directed to an adjustable height medical procedure table that includes a platform and a base. The platform can support a patient and includes an examination surface.

The base supports the platform and includes a scissors lift configured to move the platform to a first low position wherein an upper surface of the examination surface is 19 inches above a floor or lower. In one embodiment, the scissors lift is configured to move the platform to a second high position at least 19 inches higher than the first low position, and any position therebetween. Preferably, the upper surface of the examination surface is at least 38 inches above the floor.

In certain embodiments, the examination surface has a recess and an insert having a shape complimentary to the recess and pivotally mounted within the recess.

In another embodiment, the table of the present invention includes an insert guide configured to divert the insert from a vertical position. Preferably, the insert guide does not utilize sensors. One exemplary embodiment of an insert guide is a spring affixed to the insert or another portion of the platform that is configured to maintain the insert away from the vertical position when the spring is not engaged by a user. Another exemplary embodiment of an insert guide is an angled upper surface of the base configured to guide the insert guide away from the vertical position when the insert contacts the insert guide as the platform is lowered.

In yet another embodiment, the table of the present invention includes a top lift slot located in the platform or base. An upper portion of the scissors lift is slidably mounted in the top lift slot by sleeve bearings that are engaged in the top lift slot. Preferably, the base includes a base frame having a base slot. A lower portion of the scissors lift is slidably connected to the base by sleeve bearings engaged in the base slot and connected to the scissors lift. Preferably, the sleeve bearings engaged in the top lift slot and/or the sleeve bearings engaged in the base slot are formed from bronze.

In an embodiment, the table of the present invention includes a control system programmed to prevent the platform from contacting the floor or other elements of the table. Preferably, the control system prevents contact by limiting the tilt and height movements of the platform based on the platform's position.

In an additional embodiment, the table of the present invention includes a side rail movable between a first side rail position at least partially covering the recess and a second side rail position that does not cover the recess. The side rail may be configured to slide between the first side rail position and the second side rail position.

Alternatively, the side rail is removably attached to the platform or base using a mounting bar, and the mounting bar is not centered between a first end and a second end of the side rail. Preferably, the mounting bar is positioned within a portion of the side rail extending from 15% to 35% between the first end and the second end.

Another embodiment of the table of the present invention includes a side rail mount slidably attached to the platform or base and configured to slide between a first position covered by the platform and a second position extending outward from the platform.

Yet another embodiment of the table of the present invention includes a base or platform that includes a hinge to allow movement of the platform to the Trendelenburg and reverse Trendelenburg positions. The hinge is positioned within the center 50% portion along a length of the platform. Preferably, the hinge is positioned above the scissors lift.

In one embodiment, the base of the table of the present invention includes wheels to enable the table to be rolled.

In yet another embodiment of the table of the present invention, the examination surface comprises a seat section and a backboard section pivotally connected to the seat section, wherein the backboard section is configured to pivot above the plane of the seat section to a reclining configuration.

In certain embodiments, the table of the present invention includes a pad affixed to an outer corner of the recess.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a side view of one embodiment of the adjustable height medical procedure table of the present invention in a lowered position and in a table configuration.

FIG. 2 is a side view of the table of FIG. 1 in an elevated position and in a table configuration.

FIG. 3 is a side view of the table of FIG. 1 in an elevated position and in a chair or reclining configuration.

FIG. 4 is a perspective view of the table of FIG. 1 in an elevated position and in a table configuration.

FIG. 5 is a sectional side view of the table of FIG. 1.

FIG. 6 is a side view of the table of FIG. 1 in an elevated position and in a Trendelenburg position.

FIG. 7 is a side view of the table of FIG. 1 in an elevated position and in a Reverse Trendelenburg position.

FIG. 8 is a perspective end view of the table of FIG. 1 in an elevated position and in a table configuration.

FIG. 9 is an end view of the table of FIG. 1 with an insert guide of the present invention.

FIG. 10 is an end view of the table of FIG. 1 with an insert of the present invention.

FIG. 11 is a side view of the table of FIG. 1 showing one embodiment of a side rail of the present invention.

FIG. 12 is a side view of the table of FIG. 11, showing the side rail in a second configuration.

FIG. 13 is a perspective view of the table of FIG. 1 showing one embodiment of a side rail mount of the present invention.

FIG. 14 is a perspective view of the table of FIG. 13, showing the side rail mount in a second configuration.

### DETAILED DESCRIPTION OF PREFERRED EMBODIMENT

One embodiment of the present invention is directed to an adjustable height medical procedure table 10. As shown in FIG. 1, medical procedure table 10 includes platform 12 and base 14. Platform 12 is configured to support a patient and includes an examination surface 17.

Preferably, table 10 is supported above the floor by base 14. Base 14 may be any support capable of supporting the patient on the apparatus. Preferably, base 14 includes a plurality of wheels 16 to allow table 10 to be moved or rolled when in the table, chair, or reclined configurations, with wheel brakes to allow table 10 to be safely maintained in a fixed location. Suitable bases 14 and wheels 16 are well-known in the art.

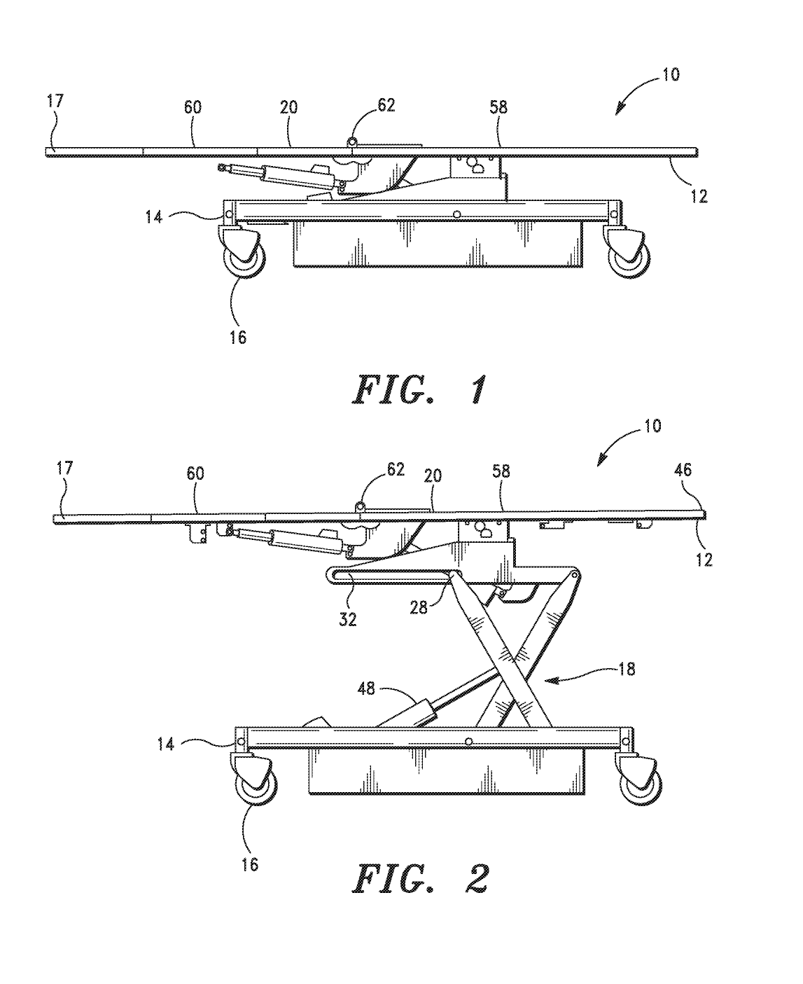

Referring to FIGS. 1 and 2, base 14 preferably includes a scissors lift 18. Scissors lift 18 is configured to move platform 12 between raised and lowered positions. Referring to FIG. 1, table 10 is shown in a first low position. Referring to FIG. 2, table 10 is shown in a second high position. Scissors lift 18 is configured to move the platform to any position between the first low position and the second high position shown in FIGS. 1 and 2. Scissors lift 18 is preferably configured to enable an upper surface 20 of examination surface 17 to reach 19 inches above the floor or lower in the first low position. Scissors lift 18 is preferably configured to enable upper surface 20 to be raised to a second high position that is at least 19 inches higher than the first low position, or at least 38 inches above the floor. When platform 12 is in the second high position, the upper surface 20 of examination surface 17 may be at least 38 inches above the floor. Scissors lift 18 and base 14 are sufficiently large to provide the required vertical range of motion of platform 12. In one preferred embodiment, scissors lift 18 is approximately 30 inches tall and base 14 is 48 inches long and 19 inches wide.

Scissors lift 18 is preferably connected to base 14 or platform 12 using sleeve bearings. In the exemplary embodiment shown in FIG. 8, an upper portion of scissors lift 18 is slidably connected to planar sections 22, 24 of base 14 by sleeve bearings 26, 28 that are engaged in respective top lift slots 30, 32 located in planar sections 22, 24 of base 14. Planar sections 22 and 24 extend vertically, are spaced apart from one another and extend longitudinally along a portion of the length of table 10. Planar sections 22, 24 include top lift slots 30, 32 which extend longitudinally in a generally horizontal direction along the length of examination surface 17. Sleeve bearings 26, 28 are engaged in top lift slots 30, 32 and are connected to an upper portion of scissors lift 18.

In such an embodiment, base 14 also includes a base frame 34 which has base slots 38. A lower portion of scissors lift 18 is slidably connected to base frame 34 by sleeve bearings 42 that are engaged in base slots 38 and connected to a lower portion of scissors lift 18, on each side of scissor lift 18 (left side hidden in FIG. 8). Preferably, sleeve bearings 26, 28 and/or sleeve bearings 42 are formed from bronze.

Although top lift slots 30, 32 are located in planar sections 22, 24 of base 14 in the embodiment shown in the Figures, it is nonetheless within the scope of the present invention for top lift slots 30, 32 to be located in platform 12. Top lift slots 30 and 32 may be located in a platform frame 44 (shown in FIG. 8) positioned below or around examination surface 17, or platform 12 may include planar sections 22, 24 extending downward from examination surface 17 toward base 14.

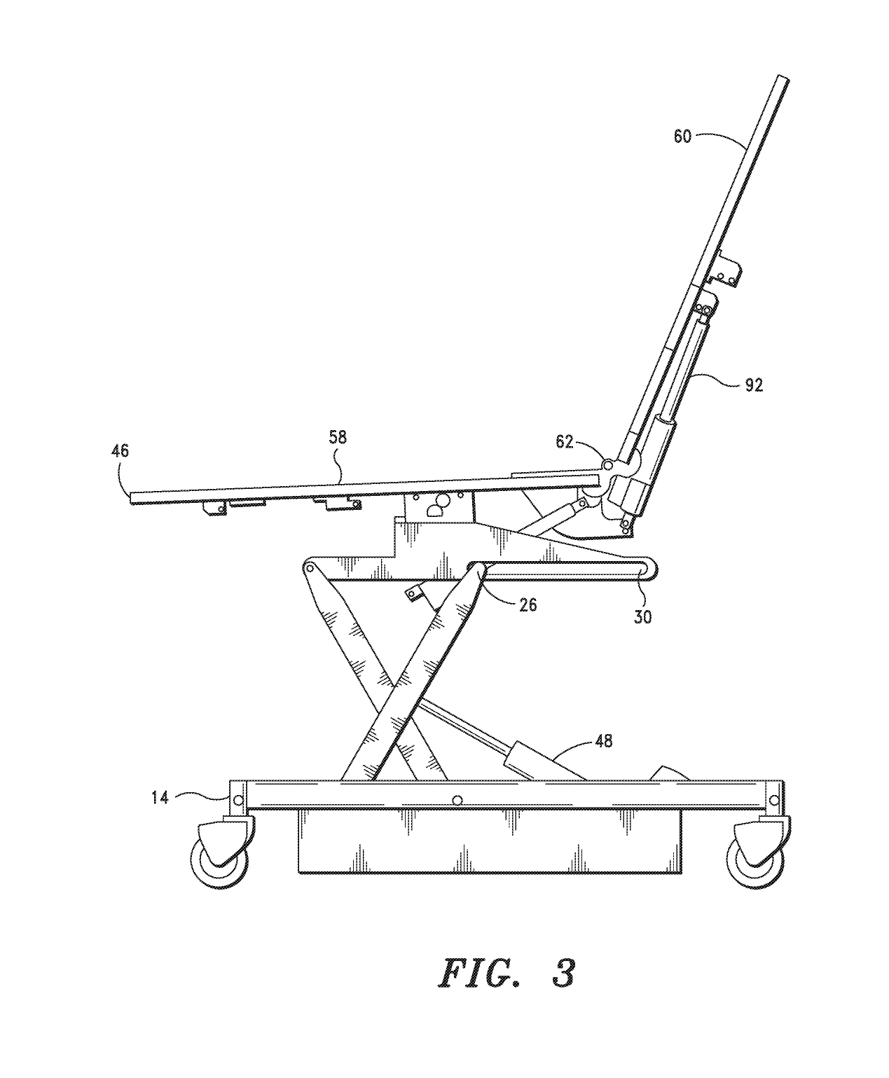

Referring to FIGS. 2 and 3, to raise scissors lift 18, which in turn raises platform 12, sleeve bearings 26, 28 are moved along top lift slots 30, 32 toward a first end 46 of platform 12, and sleeve bearings 42 are moved along base slots 38 toward first end 46 of platform 12. To lower scissors lift 18, which in turn lowers platform 12, the motion is reversed. Electric actuator 48 extends between and is secured to base frame 34 and scissors lift 18 and is operable to raise and lower scissors lift 18. Although the embodiment shown in the figures use electric actuator 48, other mechanisms for raising and lowering platform 12, can be used, as would be known to one skilled in the art. Further, other mechanisms for operation of scissors lift 18 and attachment to base 14 and/or platform 12 are known in the art and contemplated by the present invention.

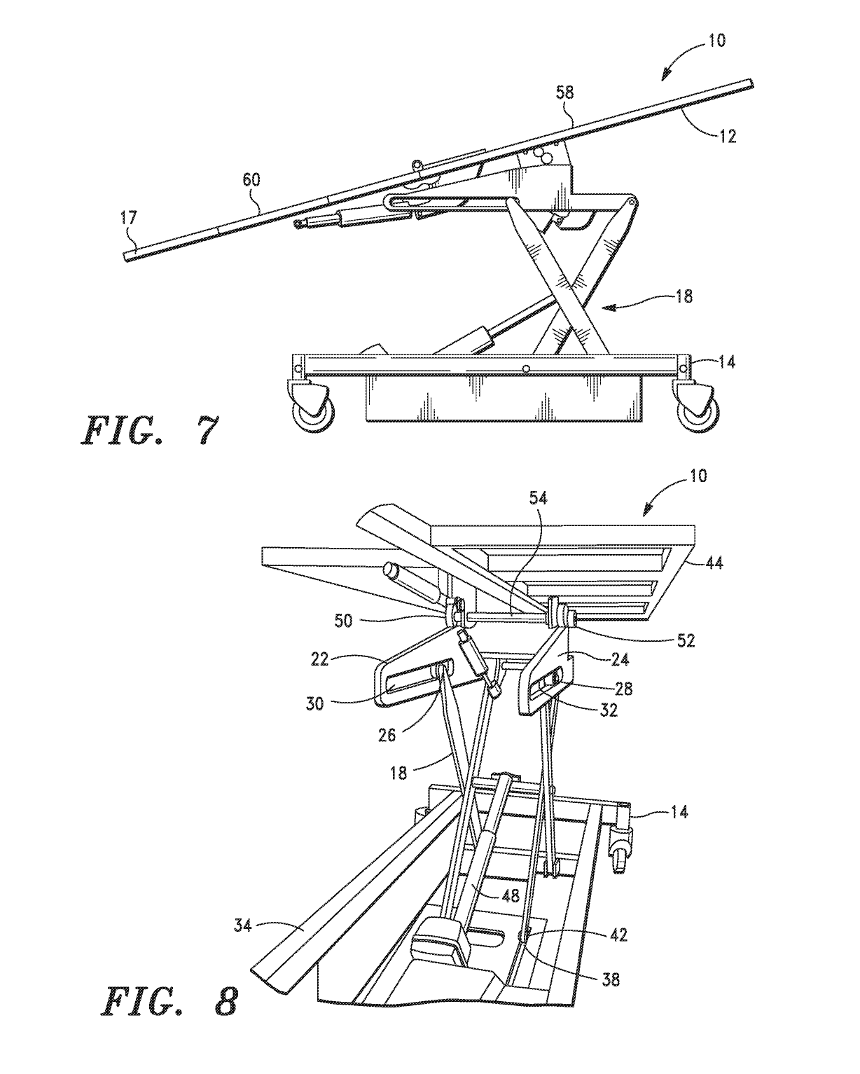

Table 10 may be configured to allow the patient to be positioned at various angles of incline and decline. For example, as depicted in FIGS. 6 and 7, examination surface 17 of table 10 can be moved between a Trendelenburg and reverse Trendelenburg positions. Scissors lift 18 is configured to raise and lower examination surface 17 while in both Trendelenburg and reverse Trendelenburg positions without hitting the floor or base 14. Preferably, table 10 includes a control system (not shown) programmed to prevent platform 12 from contacting the floor or other elements of the table. Preferably, the control system prevents contact by limiting the tilt and height movements of platform 12 based on the position of platform 12. Control systems for medical examination tables are known in the art.

In the exemplary embodiment shown in FIG. 8, hinges 50, 52, which are joined by hinge pin 54, join platform 12 to base 14. Hinges 50, 52 allow movement of the platform to the Trendelenburg and reverse Trendelenburg positions. In the embodiment shown in FIG. 8, hinges 50, 52 attach platform frame 44 to planar sections 22, 24 of base 14 and are located above top lift slots 30, 32. However, it should be understood, hinges 50, 52 can be located in any location and position within table 10 that allows examination surface 17 to be tilted. For example, hinges 50, 52 and may be: 1) part of base 14 positioned below platform 12, 2) positioned between base 14 and platform 12, or 3) part of platform 12 between platform frame 44 and examination surface 17. Preferably, hinges 50, 52 are positioned above scissors lift 18 and are positioned within the center 50% portion along the length of the platform. Although hinges 50, 52 are described herein, any other mechanism for tilting examination surface 17 may be used, as will be readily understood to those in the art. For example, mechanisms for tilting a table in such a manner are disclosed in U.S. Pat. No. 6,353,949 to Falbo, which is incorporated herein by reference for such disclosure.

As best shown in FIG. 6, electric actuator 56 extends between and is secured to a bottom portion of examination surface 17 and an upper portion of base 14 and is operable to move platform 12 to the Trendelenburg position, the reverse Trendelenburg position, and the table configuration. Although the embodiment shown in the figures uses electric actuator 56, other mechanisms for moving platform 12 to the Trendelenburg position, the reverse Trendelenburg position, and the table configuration can be used, as would be known to one skilled in the art.

FIGS. 1 through 3 show an exemplary embodiment of table 10 wherein examination surface 17 includes a seat section 58 and a backboard section 60 pivotally connected to seat section 58 at hinge 62, although any pivotal connector can be used. Backboard section 60 is configured to pivot above the plane of seat section 58 to a reclined or chair configuration. Base 14 is located under seat section 58. Table 10 may also include a foot section pivotally connected to seat section 58.

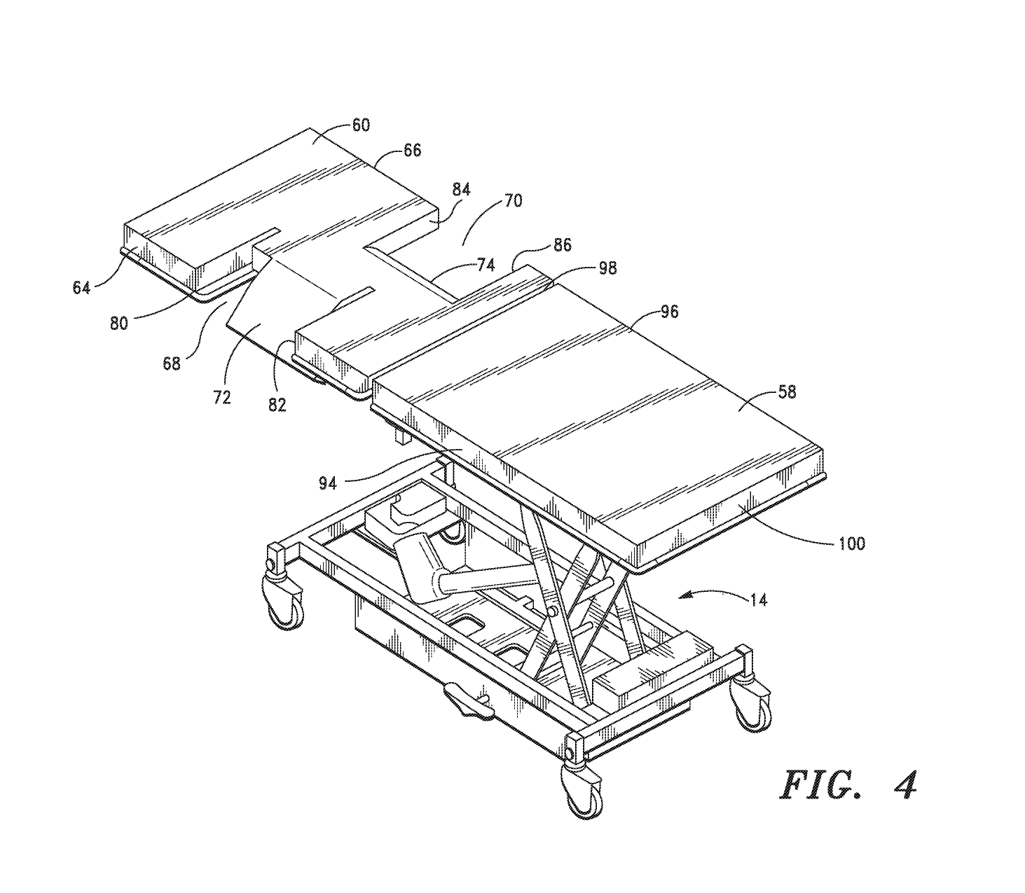

Referring to FIG. 4, backboard section 60 is configured with opposing first edge 64 and second edge 66. Backboard section 60 preferably comprises one or more recesses 68 and 70 along first edge 64 and/or second edge 66, preferably one recess 68 along first edge 64 and one recess 70 along second edge 66. Recesses 68 and 70 are of sufficient depth and length to allow access to a patient supported on backboard section 60 by a technician or a medical device. The table of the present invention can be used with a wide variety of medical devices and procedures. In certain embodiments, table 10 is particularly suited for use during heart ultrasound procedures.

Referring back to FIG. 4, backboard section 60 preferably includes inserts 72 and 74 complimentary in size and shape to recesses 68 and 70. Inserts 72 and 74 can be removably or pivotally mounted in recesses 68 and 70 to allow access to recesses 68 and 70 by the technician or a medical device. Various types of inserts and attachments are known in the art, and exemplary back board recesses and back board inserts are described as access sites and filler sections, respectively, in U.S. Pat. No. 6,557,196 to Falbo, Sr. et al., U.S. Pat. No. 5,950,262 to Smoler et al., and U.S. Pat. No. 5,184,363 to Falbo, Sr., each of which is incorporated by reference with respect to such disclosure.

Preferably, table 10 includes at least one insert guide that is configured to divert an insert from a vertical position when the insert is pivotally mounted in a recess of table 10. The insert guide diverts the insert into a position that is not vertical, which in turn protects the inserts of table 10 from crashing or slamming into other components of table 10 as platform 12 is raised and lowered by scissors lift 18. This reduces the risk of damage to table 10 and the risk of injury to a patient positioned on table 10. In one embodiment, the insert guides do not utilize sensors.

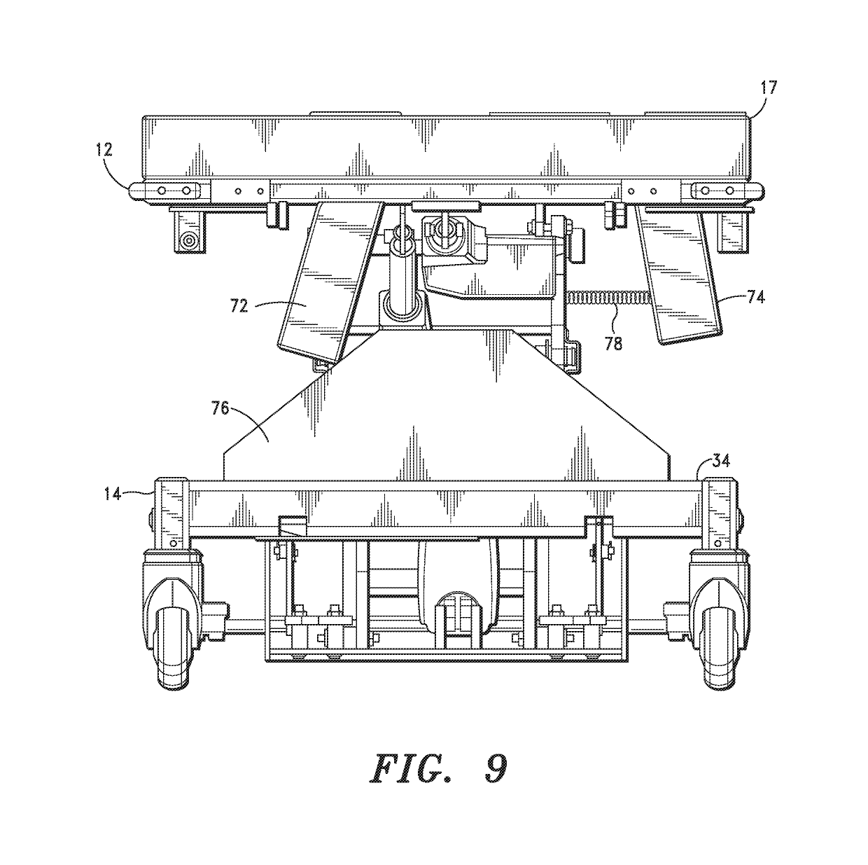

In one embodiment shown in FIG. 9, insert guide 76 is an angled upper surface of base frame 34 that is positioned beneath insert 72 and recess 68 (not shown) that is configured to guide insert 72 away from the vertical position when insert 72 contacts insert guide 76 as platform 12 is lowered. As platform 12 is lowered by scissors lift 18 while insert 72 is hanging vertically from platform 12, insert 72 comes into contact with insert guide 76, which causes insert 72 to rotate clockwise away from the vertical position as a lower edge of insert 72 slides down insert guide 76. Raising platform 12 from this position will cause insert 72 to rotate back to vertical as a lower edge of insert 72 slides up insert guide 76 and eventually returns to the vertical position once insert 72 is no longer in contact with insert guide 76.

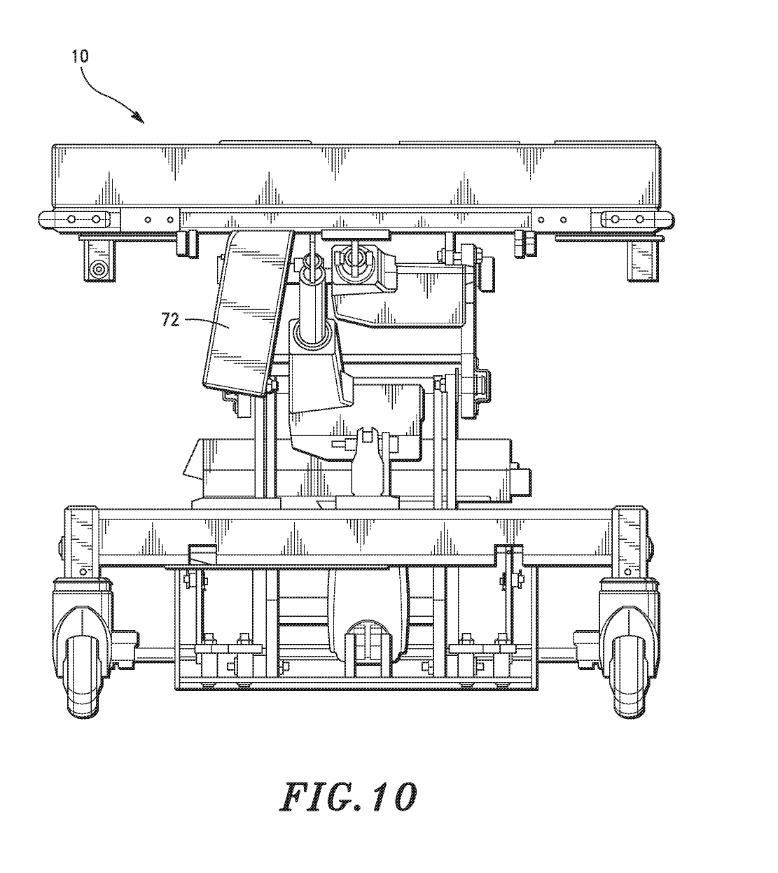

In another embodiment shown in FIG. 9, insert guide 78 is a spring that is configured to maintain insert 74 away from the vertical position when the spring is not engaged by the user. As shown, insert guide 78 is affixed to a bottom surface of insert 74. Alternatively, insert guide 78 can be affixed to another portion of the platform or an upper portion of base 14. When insert 74 is hanging down from platform 12, insert guide 78 contacts a bottom portion of platform 12 or base 14 and prevents insert 74 from being vertically oriented. Insert guide 78 can be engaged by a medical care provider by pushing insert 74 toward insert guide 78. Engaging insert guide 78 allows a medical care provider to move insert 74 out of the provider's way in order to complete an exam or procedure. Insert guide 78 can be engaged with a medical care provider's leg or knee so that the medical care provider's hands are free. Spring 78 may be any material or device that will maintain insert 74 away from the vertical position when not engaged but can be reversibly engaged by the user to a vertical, or past vertical position. FIG. 10 shows a table 10 of the present invention with insert 72, but no insert guide.

Referring to FIG. 4, recesses 68, 70 are preferably at least 15 inches in length, and are preferably between 10 and 20 inches in length, any length or range within such range, or longer. In one exemplary embodiment recesses 68 and 70 are 15 inches in length. In embodiments having more than one recess, recesses can be the same or different lengths. Recesses 68 and 70 can be any shape that allows access to the patient. Recesses 68 and 70 are preferably at least 8 inches deep, preferably at least 5 inches deep and in certain embodiments are between 8 and 15 inches deep our any depth or range of depths therebetween. Recesses 68 and 70 can comprise ends 80, 82, 84 and 86 defined by backboard section 60 as depicted in the Figures. Alternatively, recesses can extend the entire length of backboard section 60.

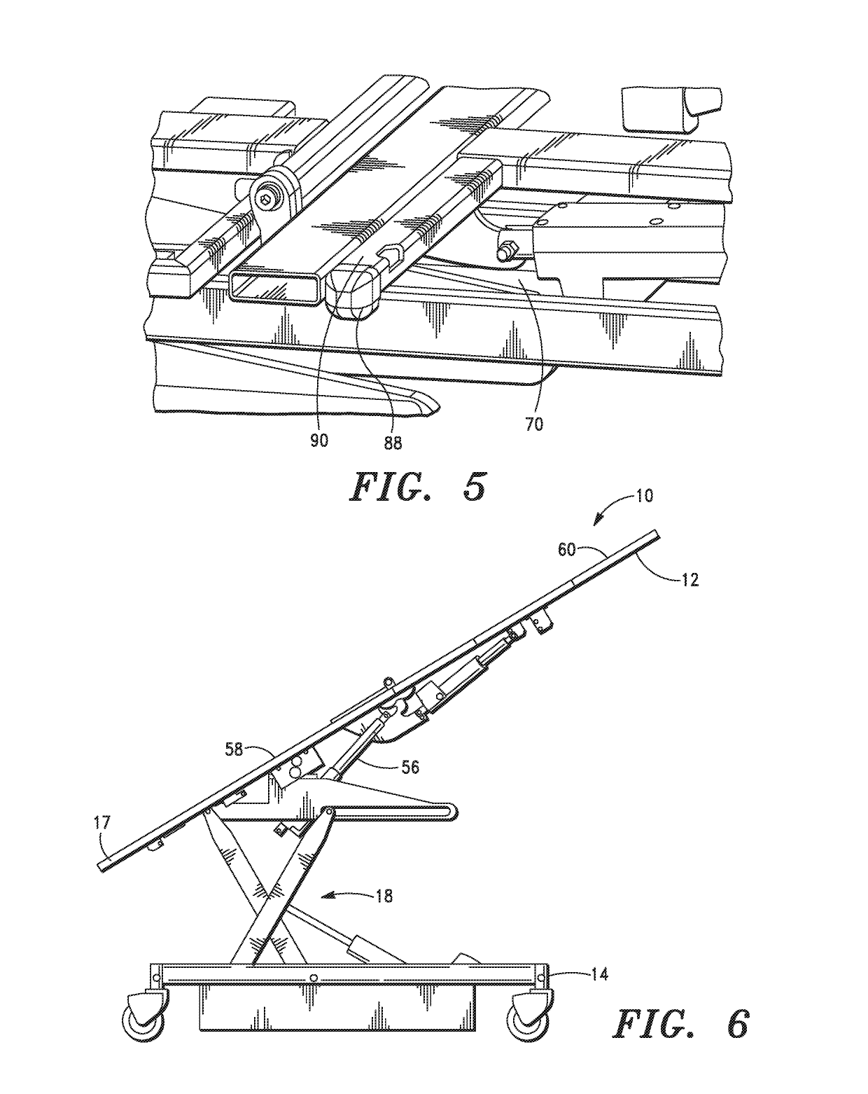

Turning to FIG. 5, pad 88 may be affixed to an outer corner 90 of one or more recesses 68, 70. As a technician or medical care provider is examining a patient positioned on table 10, the pad or covering provides the medical care provider protection from the sharp corners and edges of recess 70. The pad can be formed of any relatively soft material such as fabric, foam, soft plastic or similar materials.

Table 10 can be converted from a chair or reclined configuration (the Fowler's position) depicted in FIG. 3 to a table configuration depicted in FIGS. 1 and 2 by pivoting backboard section 60 above the plane of the seat section 58. In certain embodiments, backboard section 60 can be pivoted above the plane of seat section 58 up to 90 degrees above horizontal, and more preferably up to 65 degrees above horizontal. Seat section 58 is in a generally horizontal position in the chair, reclined, and table configurations. Table 10 can be returned to a reclined configuration by reversing the movement. Suitable pivotal attachment arrangements for moving backboard section 60 to convert a procedure table between a reclining or chair position and a procedure table are well known in the art.

As shown in FIG. 3, electric actuator 92 extends between and is secured to a bottom portion of backboard section 60 and a lower portion of seat section 58. Electric actuator 92 is operable to move table 10 from a chair or reclined configuration to a table configuration. Although the embodiment shown in the figures use electric actuator 92, other mechanisms for moving table 10 from a chair or reclined configuration to a table configuration and vice-versa can be used, as would be known to one skilled in the art. Scissors lift 18 is configured to move platform 12 up and down when table 10 is in the table, chair, or reclined positions.

Referring to FIG. 4, backboard section 60 is of a size and general shape suitable for supporting the torso of a horizontal patient when table 10 is in the table configuration and for supporting the back of a seated or reclined patient when table 10 is in the chair or reclined configuration. In certain embodiments, backboard section 60 may be from 30 to 50 inches in length along first and second edges 64 and 66, preferably between 35 and 45 inches in length. The width of backboard section 60 between first and second edges 64 and 66, including any inserts, is preferably between 20 and 40 inches wide.

Seat section 58 is of a size and general shape suitable for supporting a seated or reclined patient when table 10 is in the chair or reclined configuration. Seat section 58 has opposing first and second edges 94 and 96 generally parallel to first and second edges 64 and 66 of backboard section 60 and has first and second ends 98 and 100. In certain embodiments, seat section 58 is between 30 and 50 inches long, along edges 94 and 96 and between 20 and 40 inches wide between edges 94 and 96.

When table 10 is in the table configuration and backboard section 60 and seat section 58 are generally planar, seat section 58 may be tilted relative to base 14, causing the plane of backboard section 60 and seat section 58 to incline or decline to thereby either raise backboard section 60 and lower seat section 58, or raise seat section 58 and lower backboard section 60, in Trendelenburg or Reverse Trendelenburg position, as shown in FIGS. 6 and 7.

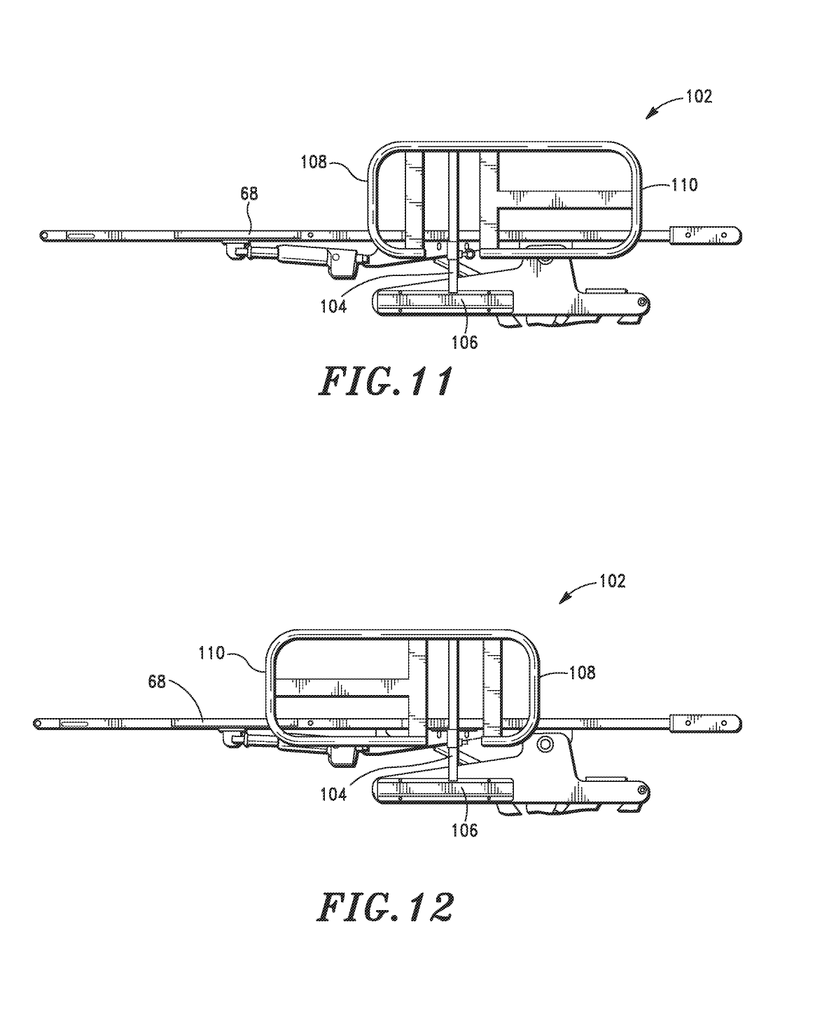

Turning to FIGS. 11 and 12, table 10 may also include a side rail 102 that is movable between one side rail position at least partially covering one of the recesses 68, 70 as shown in FIG. 11, and a second side rail position that does not cover one of the recesses 68, 70 as shown in FIG. 12. Side rails are well known in the art.

In the embodiment shown in FIGS. 11 and 12, side rail 102 includes mounting bar 104 that extends down from side rail 102 and is secured to or removably attached to mounting bar support 106 on platform frame 44. In an alternative embodiment, mounting bar 104 may be on another portion of platform 12 or base 14.

In one embodiment, side rail 102 is configured to slide between one side rail position at least partially covering one of the recesses and a second side rail position that does not cover one of the recesses. In such an embodiment, mounting bar support 106 includes a track (not shown) within which mounting bar 104 is engaged and within which mounting bar can be slidably moved by a user between positions. It will be understood that, unlike the embodiment shown in FIGS. 11 and 12, in such an embodiment the orientation of side rail 102 would not change (i.e.—it would not be rotated) when moving side rail 102 from one position to another.

In an embodiment shown in FIGS. 11 and 12, mounting bar 104 of side rail 102 is removably attached to mounting bar support 106 such that it can be moved from one side rail position at least partially covering recess 68 (as shown in FIG. 12) to a second side rail position that does not cover recess 68 (as shown in FIG. 11) by removing mounting bar 104 from mounting bar support 106, rotating side rail 102 approximately 180 degrees, and placing mounting bar 104 back into mounting bar support 106. In the embodiment shown in FIGS. 11 and 12, the mounting bar 104 is not centered between a first end 108 and a second end 110 of side rail 102. Preferably, mounting bar 104 is positioned within a portion of the side rail extending from 15% to 35% between first end 108 and second end 110.

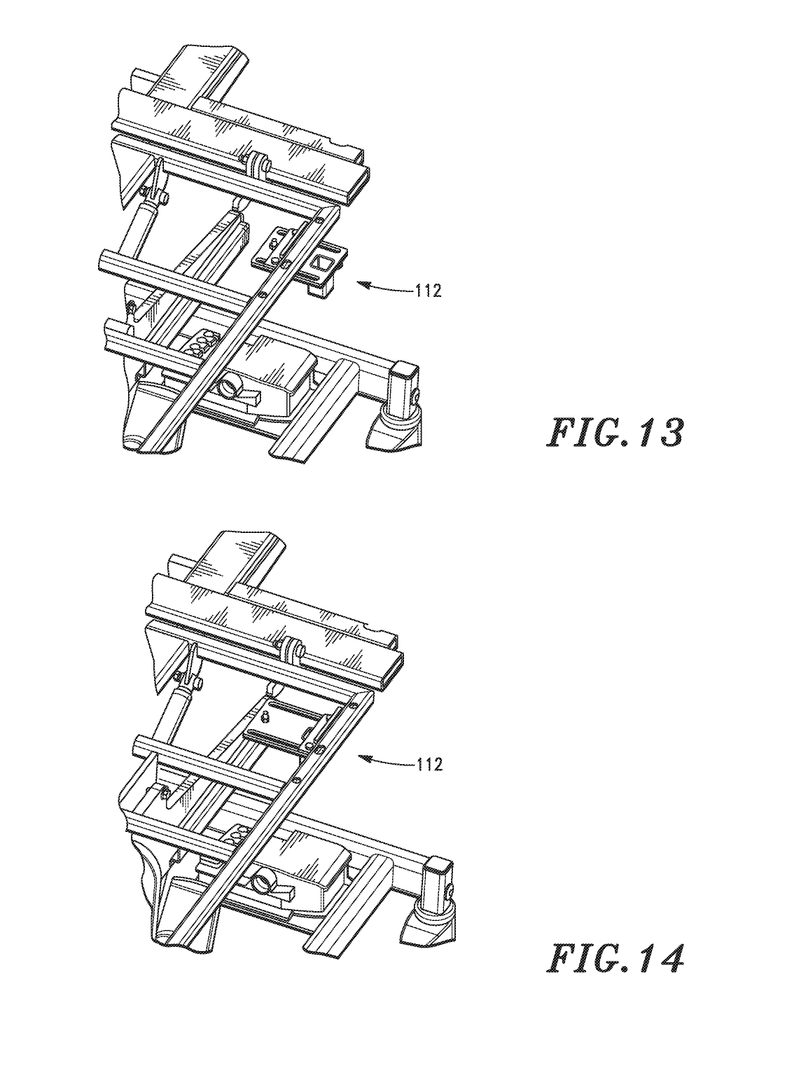

In one embodiment shown in FIGS. 13 and 14, table 10 includes a side rail mount 112 slidably attached to platform 12 that is configured to slide between a first position covered by platform 12 (FIG. 13) and a second position extending outward from platform 12 (FIG. 14). This prevents side rail mount 112 from injuring the patient or other user if the side rail is not in place on table 10. It should be understood that slide rail mount 112 may also be affixed to base 14. In addition, slide rail mount 112 may be pivotally attached or otherwise attached in a manner that allows it to be move between a position covered by platform 12 and extending outward from platform 12.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. An adjustable height medical procedure table comprising:
a platform for supporting a patient, wherein the platform comprises an examination surface and
a base supporting the platform, wherein the base comprises a scissors lift configured to move the platform to a first low position wherein an upper surface of the examination surface is 19 inches above a floor or lower.

2. The table of claim 1, wherein the scissors lift is configured to move the platform to a second high position at least 19 inches higher than the first low position, and any position therebetween.

3. The table of claim 2, wherein in the second high position, the upper surface of the examination surface is at least 38 inches above the floor.

4. The table of claim 1, wherein the examination surface has a recess and further comprising:
and an insert having a shape complimentary to the recess and pivotally mounted within the recess; and
an insert guide configured to divert the insert from a vertical position.

5. The table of claim 4, wherein the insert guide does not utilize sensors.

6. The table of claim 4, wherein the insert guide comprises a spring affixed to the insert or another portion of the platform, wherein the spring is configured to maintain the insert away from the vertical position when the spring is not engaged by a user.

7. The table of claim 4, wherein the insert guide comprises an angled upper surface of the base configured to guide the insert away from the vertical position when the insert contacts the insert guide as the platform is lowered.

8. The table of claim 1, further comprising a top lift slot located in the platform or the base, wherein an upper portion of the scissors lift is slidably mounted in the top lift slot by sleeve bearings engaged in the top lift slot.

9. The table of claim 8, wherein the base comprises a base frame having a base slot, and wherein a lower portion of the scissors lift is slidably connected to the base by sleeve bearings engaged in the base slot and connected to the scissors lift.

10. The table of claim 8 wherein the sleeve bearings are comprised of bronze.

11. The table of claim 9 wherein the sleeve bearings are comprised of bronze.

12. The table of claim 1, further comprising a control system programmed to prevent the platform from contacting the floor or other elements of the table.

13. The table of claim 12, wherein the control system prevents contact by limiting the tilt and height movements of the platform based on the platform's position.

14. The table of claim 1, wherein the table comprises a side rail movable between a first side rail position at least partially covering a recess in the examination surface and a second side rail position that does not cover the recess.

15. The table of claim 14, wherein the side rail is configured to slide between the first side rail position and the second side rail position.

16. The table of claim 14, wherein the side rail is removably attached to the platform or base using a mounting bar, wherein the mounting bar is not centered between a first end and a second end of the side rail.

17. The table of claim 16, wherein the mounting bar is positioned within a portion of the side rail extending from 15% to 35% between the first end and the second end.

18. The table of claim 1, wherein the table comprises a side rail mount slidably attached to the platform or base and configured to slide between a first position covered by the platform and a second position extending outward from the platform.

19. The table of claim 1, wherein the base or platform comprises a hinge to allow movement of the platform to the Trendelenburg and reverse Trendelenburg positions and wherein the hinge is positioned within the center 50% portion along a length of the platform.

20. The table of claim 19, wherein the hinge is positioned above the scissors lift.

21. The table of claim 1, wherein the examination surface comprises a seat section and a backboard section pivotally connected to the seat section, wherein the backboard section is configured to pivot above the plane of the seat section to a reclining configuration.

22. The table of claim 1, further comprising a pad affixed to an outer corner of a recess in the examination surface.

23. A medical procedure table comprising:
a platform for supporting a patient, wherein the platform comprises an examination surface having a recess and an insert having a shape complimentary to the recess and pivotally mounted within the recess; and
a base supporting the platform;
wherein the table comprises a side rail movable between a first side rail position at least partially covering the recess and a second side rail position that does not cover the recess.

24. The table of claim 24, wherein the side rail is configured to slide between the first side rail position and the second side rail position.

25. The table of claim 24, wherein the side rail is removably attached to the platform using a mounting bar, wherein the mounting bar is not centered between a first end and a second end of the side rail.

26. The table of claim 25, wherein the mounting bar is positioned within a portion of the side rail extending from 15% to 35% between the first end and the second end.

27. The table of claim 25, wherein the table comprises a side rail mount slidably attached to the platform or base and configured to slide between a first position covered by the platform and a second position extending outward from the platform.
